(19) United States
(12) Patent Application Publication
(10) Pub. No.: US 2015/0157104 A1
(43) Pub. Date: Jun. 11, 2015

(54) PORTABLE HANDBAG FOR DISPOSAL OF PET DEFECATION

(71) Applicant: Hyun Mee JANG, Gyeyang-gu, Incheon (KR)

(72) Inventor: Hyun Mee Jang, Incheon (KR)

(21) Appl. No.: 14/411,660

(22) PCT Filed: Jun. 4, 2013
(86) PCT No.: PCT/KR2013/004914

§ 371 Date: Dec. 29, 2014

(30) Foreign Application Priority Data
Jun. 29, 2012 (KR) 10-2012-0071102

(51) Int. Cl. A45C 11/00; A01K 27/00

(52) U.S. Cl. CPC A45C 11/00; A01K 27/008

(57) ABSTRACT

Disclosed is a handbag which can easily carry wet tissues and defecation bags for disposal of pet defecation when going out with a pet such as a dog. The portable handbag for pet defecation disposal includes a container (10) for keeping wet tissues, a container cover (10b) for opening and closing the upper side thereof, a defecation pocket (10c) provided on the outside of the container cover (10b) to keep defecation bags and an auxiliary pocket (10e) for keeping vinyl bags that have collected pet defecation. Further, a strap (12) is provided at the upper end portion of one side of the handbag, a first hook (11) is provided on the lower side of the strap (12), and a ring (13) is provided at the upper end portion of the other side of the handbag opposed the strap (12), so that the handbag can be fastened easily and firmly to the lead line of the pet.

### TECHNICAL FIELD

The present invention relates to a handbag which can easily carry wet tissues and defecation bags for disposal of pet defecation when going out with a pet such as a dog.

### BACKGROUND ART

In general, when going out with a pet, one carries defecation bags for disposal of pet defecation and wet tissues to clean the feet or the anus of the pet. Wet tissues are carried to clean the defecation smearing the anus of the pet or the filth stuck on the feet before going into a house or taking the dog indoors, and defecation bags are carried to collect defecation when the pet defecates outdoors.

Defecation bags and wet tissues are usually kept in a separate bag or clothes. When the pet defecates outdoors, the defecation bag that is kept in a bag or clothes should be taken out to dispose of defecation. But when going out of doors with the pet, a belt or strap is put around the neck of the pet and a lead line is connected to the belt or strap and it is held in one hand. Thus, it is very inconvenient to dispose of the defecation, with one hand holding the lead line and the other hand only being used to dispose of the defecation of the pet. Further, even if defecation is collected to be disposed of, the place to keep the collected defecation is not easily available.

Further, also when moving the pet into a car or indoors, it is very inconvenient because only one hand is used to take out wet tissues and clean the pet while the other hand is holding the pet.

### DISCLOSURE OF INVENTION

### Technical Problem

Accordingly, it is an object of the present invention to provide a portable handbag that can be carried very conveniently to dispose of pet defecation as well as effectively keep articles such as wet tissues or defecation bags for disposal of pet defecation.

Another object of the present invention is to provide a portable handbag for disposal of pet defecation, whereby pet defecation is easily disposed of and cleaning can be easily done for the pet using only one hand.

### Solution to Problem

A portable handbag for keeping articles for pet defecation disposal according to a first aspect of the present invention, includes: a strap provided at an upper end portion of one side of a handbag, a first hook fixed to the one side of the handbag below the strap, and a ring provided at an upper end portion of the other side of the handbag opposed to the strap.

The portable handbag may further include a second hook fixed to the other side of the handbag below the ring.

Preferably, the ring is a hook.

Preferably, the strap is fastened to the first hook after passing through a handgrip attached to a housing of an automatically wound type lead line.

Preferably, a handgrip of a pet lead line is fastened to the first hook.

A portable handbag according to a second aspect of the present invention, includes: a container having a space to keep wet tissues, a container cover coupled with the container to open and close the upper side thereof, a defecation pocket formed on an outside of the container cover to keep defecation bags, and an auxiliary pocket formed on an outside of the container cover at intervals with the defecation pocket to keep vinyl bags that have collected pet defecation, wherein the container includes a hole formed on the front thereof to draw out wet tissues kept in the container.

Preferably, the defecation pocket is detachably coupled with the container.

The portable handbag may further include a strap provided at an upper end portion of one side of the container, a first hook fixed to the one side of the container below the strap, and a ring provided at an upper end portion of the other side of the container opposed to the strap.

The portable handbag may further include a cover provided on the front of the container to open and close the hole.

### Advantageous Effects of Invention

According to the present invention with the above mentioned configuration, it is possible to provide a portable handbag that can effectively keep articles for disposal of pet defecation when going out with the pet. Further, the handbag of the present invention is combined easily and firmly with the lead line of the pet, so that it is very convenient to use articles as well as easy to carry the articles of defecation disposal.

### BRIEF DESCRIPTION OF DRAWINGS

FIG. 1 and FIG. 2 are perspective diagrams showing a closed state and an open state of a portable handbag for pet defecation disposal according to a first embodiment of the present invention, respectively.

FIG. 3 is a front view of the portable handbag shown in FIG. 1.

FIG. 4 is a sectional view of the portable handbag shown in FIG. 1.

FIG. 5 and FIG. 6 are perspective diagrams showing the in-use state of the portable handbag shown in FIG. 1.

FIG. 7 is a front view for describing the in-use state of the portable handbag according to the first embodiment of the present invention having a lead line of the pet combined therewith.

FIG. 8 is a front view of a portable handbag for pet defecation disposal according to a second embodiment of the present invention.

FIG. 9 is a sectional view of the portable handbag shown in FIG. 8.

FIG. 10 is a front view of a portable handbag for pet defecation disposal according to a third embodiment of the present invention.

FIG. 11 is a front view of a portable handbag for pet defecation disposal according to a fourth embodiment of the present invention.

### BEST MODE FOR CARRYING OUT THE INVENTION

Hereinafter, preferable embodiments of the present invention will be described with reference to the accompanying drawings. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art.

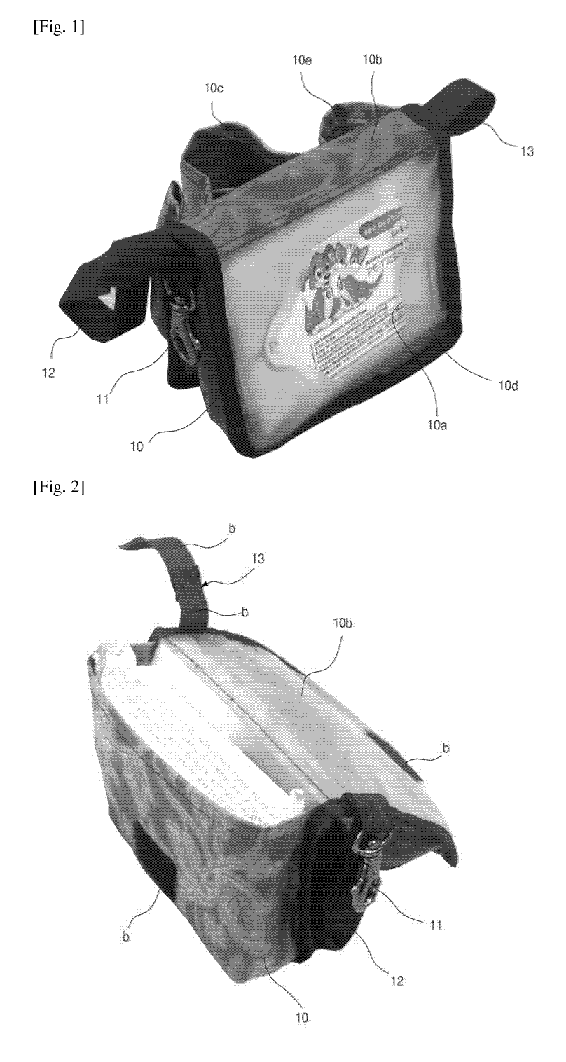

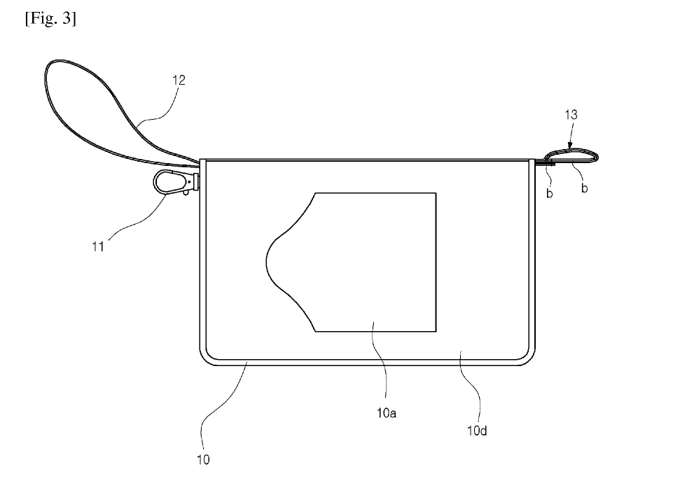

FIG. 1 and FIG. 2 are perspective diagrams showing a closed state and an open state of a portable handbag for pet defecation disposal according to a first embodiment of the present invention, respectively, and FIG. 3 is a front view of the portable handbag shown in FIG. 1.

In these drawings, the portable handbag for pet defecation disposal according to the first embodiment of the present invention includes a container 10 having a space for keeping wet tissues, a container cover 10b coupled with the container to open and close the upper side thereof, and a defecation pocket 10c formed on an outside of the container cover 10b for keeping defecation bags and other articles.

The container 10 has a space formed therein to receive and keep wet tissues. The container 10 includes a strap 12 provided at an upper end portion of one side thereof for fixing by winding the handbag around the wrist, etc, and a first hook 11 fixed to the one side thereof below the strap 12 for hooking a lead line connected to the pet.

A ring 13 is formed at an upper end portion of the other side of the container 10 opposed to the strap 12 for inserting and grasping the lead line connected to the pet. One side of the ring 13 is immovably fixed to the container 10 and the other side thereof is detachably coupled with the container 10 by an adhesive tape (for example, Velcro™ fastener) b.

The above mentioned ring 13 is formed by gluing a Velcro fastener, for example. Therefore, a user can adjust the size of the ring 13 suitably by forming a Velcro fastener of a desired diameter.

The front of the container 10 is composed of a plastic plate 10d. This plastic plate 10d includes a hole 10a for drawing out wet tissues kept in the container 10. The wet tissues are not particularly limited and all types of wet tissues that are commercially available from the market may be used.

However, considering the role as a wet tissue, it is preferable to use wet tissues of such a type in which a sticker for opening and closing is provided on the front, so that the wet tissue is drawn out after the sticker is detached and the tissue is attached again to prevent the tissues in it from drying.

Preferably, the plastic plate 10d is formed of a plastic film or a plastic sheet. The material of the plastic plate 10d is not particularly limited. However, considering that a wet tissue provided with a sticker is used, it is preferable to use as the material of the plastic plate 10d one which a sticker can be easily detached from and attached to.

In this case, the hole 10a may be opened and closed by a sticker detachably fixed to a case of the wet tissues for opening and closing. That is, after the sticker provided on the case of the wet tissue is removed from the case, then the sticker is detachably fixed to the front outside the plastic plate 10d around the hole 10a. Thus, the sticker may be used as a cover for opening and closing the hole 10a for selectively drawing out the wet tissue.

The container 10 includes a male Velcro fastener b attached to the backside thereof. The container 10 also includes a container cover 10b coupled therewith for covering the upper side thereof. One side of the container cover 10b is immovably fixed to the upper portion of the one side of the container 10, and the other side thereof is detachably coupled with the container 10 by a female Velcro fastener b. The female Velcro fastener b is fixed to an inside of the container cover 10b corresponding to the male Velcro fastener b of the container 10. As the fixing means of the container cover 10b, any other different one may be used.

An auxiliary pocket 10e is provided on the outer surface of the container cover 10b at intervals with the defecation pocket 10c. A male Velcro fastener b is attached to an upper end portion of the outer surface of the container cover 10b, a female Velcro fastener b is attached to an inner surface of the auxiliary pocket 10e at the same level with the male Velcro fastener b of the container cover 10b. The upper portion of the auxiliary pocket 10e is opened and closed by the Velcro fasteners b. Of course, as the opening and closing means of the container 10, any other coupling means besides the Velcro fastener may be used. The auxiliary pocket 10e may be used for keeping defecation collecting vinyl that has pet defecation in it.

As mentioned above, the portable handbag of the present invention has a defecation pocket 10c formed on the outside of the container 10. The defecation pocket 10c keeps common defecation bags in which defecation collecting vinyl bags for collecting pet defecation are stacked.

In the present embodiment, the defecation pocket 10c is illustrated to be positioned outside of the auxiliary pocket 10e, but the position of the defecation pocket 10c is not limited to a particular place. For example, the defecation pocket 10c may be disposed properly on the left side or right side of the container 10.

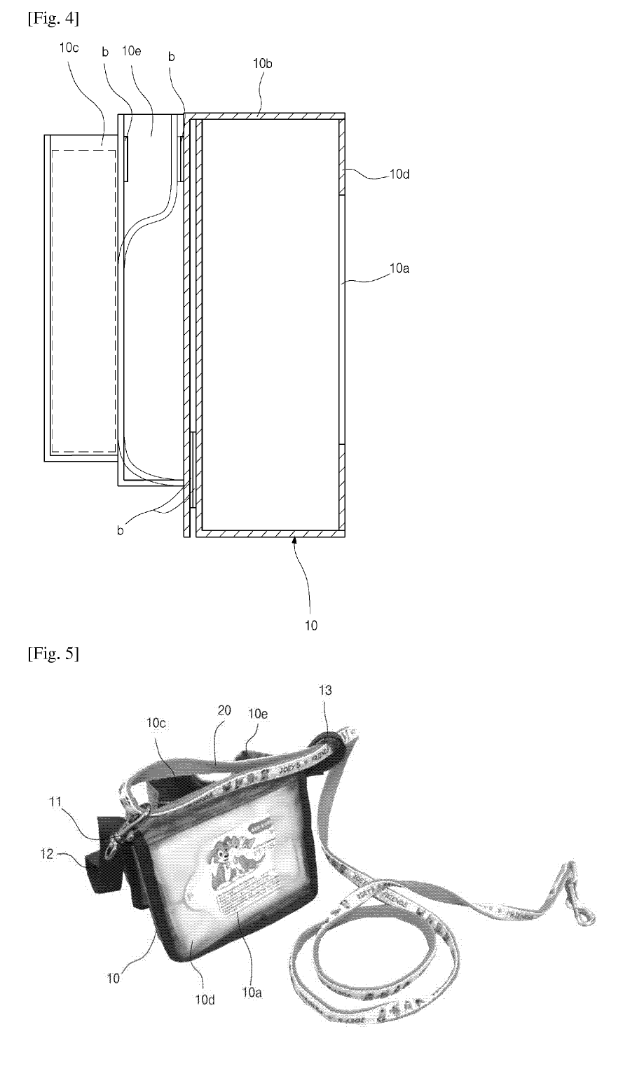

The portable handbag for pet defecation disposal according to the present invention is carried conveniently in combination with the lead line of the pet instead of being carried personally by the user. FIGS. 5 to 7 are in-use state diagrams for describing how to combine the portable handbag according to the present invention with the lead line of the pet.

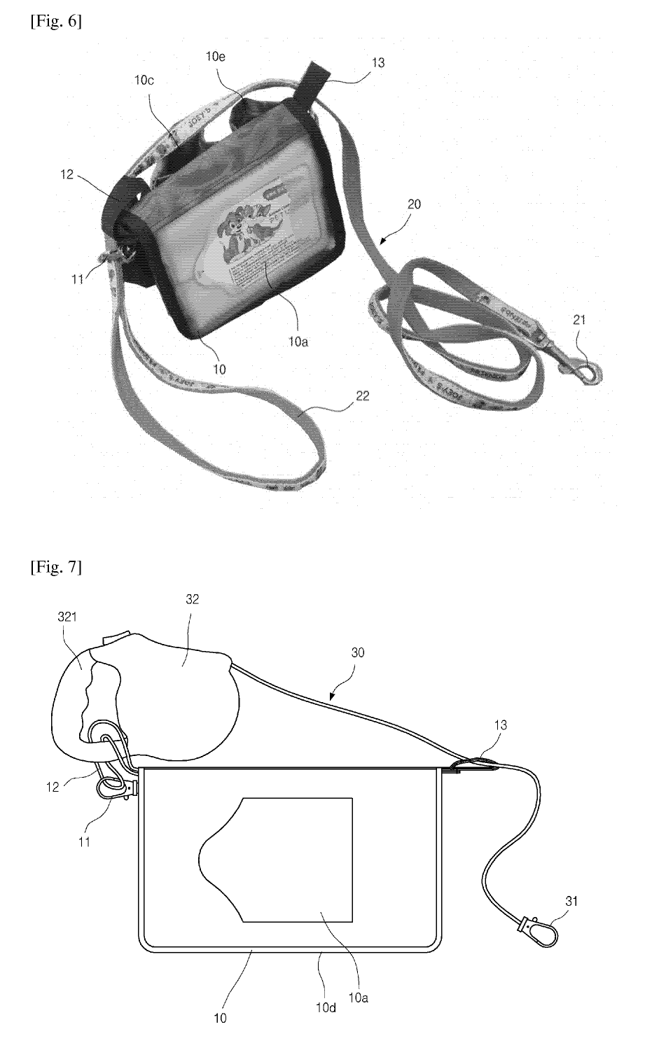

The lead lines for the pet are largely classified into a general type and an automatically wound type. The general type lead line 20 is provided at one end with a hook 21 combined with a belt or strap put around the neck of the pet and at the other end with a ring-shape handgrip 22 for the user to hold the lead line by hand, as shown in FIG. 5 and FIG. 6.

In addition, the automatically wound type lead line 30 is provided with a hook 31 fixed to one end thereof and a housing 32 fixed to the other end thereof for drawing out or keeping a lead line 30 according to the tensile force of the lead line 30. The housing 32 is provided with a handgrip 321 formed on outside thereof for the user to hold it easily by hand, as shown in FIG. 7.

FIG. 5 and FIG. 6 are perspective diagrams showing the state in which the handbag according to the present invention is installed on a general type lead line 20.

In FIG. 5, the handgrip 22 of the general type lead line 20 is fastened to the first hook 11 fixed to the one side of the handbag, and the lead line 20 is again fastened to the ring 13 provided at the other end thereof. As shown in FIG. 6, the lower portion of the handgrip 22 of the lead line 20 is fastened to the first hook 11, and the lead line 20 is again fastened to the ring 13 provided at the other end of the handbag, as shown in FIG. 5.

In FIG. 5 and FIG. 6, if the user holds by hand the lead line 20 between the first hook 11 of the handbag and the ring 13 portion, the handbag is rested firmly on the lead line 20.

Therefore, it is possible to take out a vinyl bag for defecation collection from the defecation pocket 10c of the handbag to dispose of pet defecation and store the vinyl bag after disposal in the auxiliary pocket 10e easily.

Further, in this state, after grabbing the pet with the hand that is holding the lead line 20, a wet tissue can be easily drawn out through the hole 10a of the container 10 with the other hand, and the action of storing the used wet tissue again in the auxiliary pocket 10e can be easily carried out.

FIG. 7 is a state diagram showing the state in which the handbag according to the present invention is rested on an automatically wound type lead line 30.

In FIG. 7, after passing the strap 12 of the handbag through the handgrip 321 provided on the housing 32 of the automatically wound type lead line 30, the terminal end is fastened to the first hook 11. That is, the lead line 30 is fixed on one side of the handbag through the housing 32.

In addition, the hook 13 is combined with the lead line 30 likewise with FIG. 5 and FIG. 6, so that the other side of the handbag is rested on the lead line 30.

Therefore, also in this case, when the user holds the handgrip 321 of the automatically wound type lead line 30, the handbag is combined firmly with the lead line 30.

Further, at this time the lead line 30 is drawn in and out smoothly through the ring 13, so the original action of the automatically wound type lead line 30 is not affected at all.

In addition, since the method of using defecation collecting vinyl bags and wet tissues in this state is substantially identical to the above description, a specific description for it is omitted.

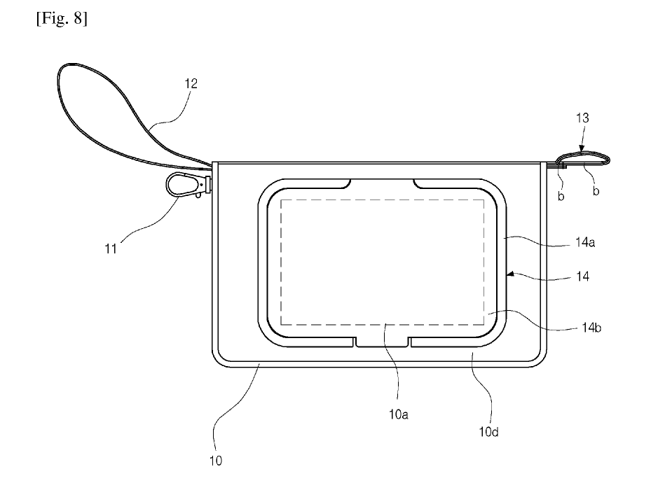

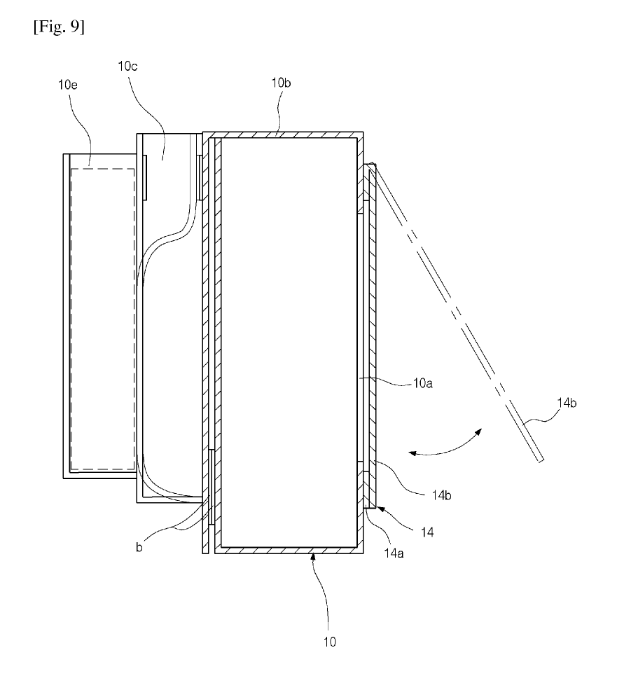

FIG. 8 is a front view of a portable handbag for pet defecation disposal according to a second embodiment, and FIG. 9 is a sectional view thereof.

The portable handbag according to the present embodiment is provided with a hole 10a formed on the front of the container 10 for drawing out wet tissues, and a wet tissue cover 14 for covering the hole 10a. The wet tissue cover 14 includes a frame 14a combined to the plastic plate 10d along the periphery of the hole 10a and a lid 14b whose upper end is sandwiched between the frame 14a and the container 10 for opening and closing the hole 10a.

In the present embodiment, since the user draws out wet tissues through the hole 10a by opening and closing the lid 14b, the drawing out action of wet tissues can be performed more easily.

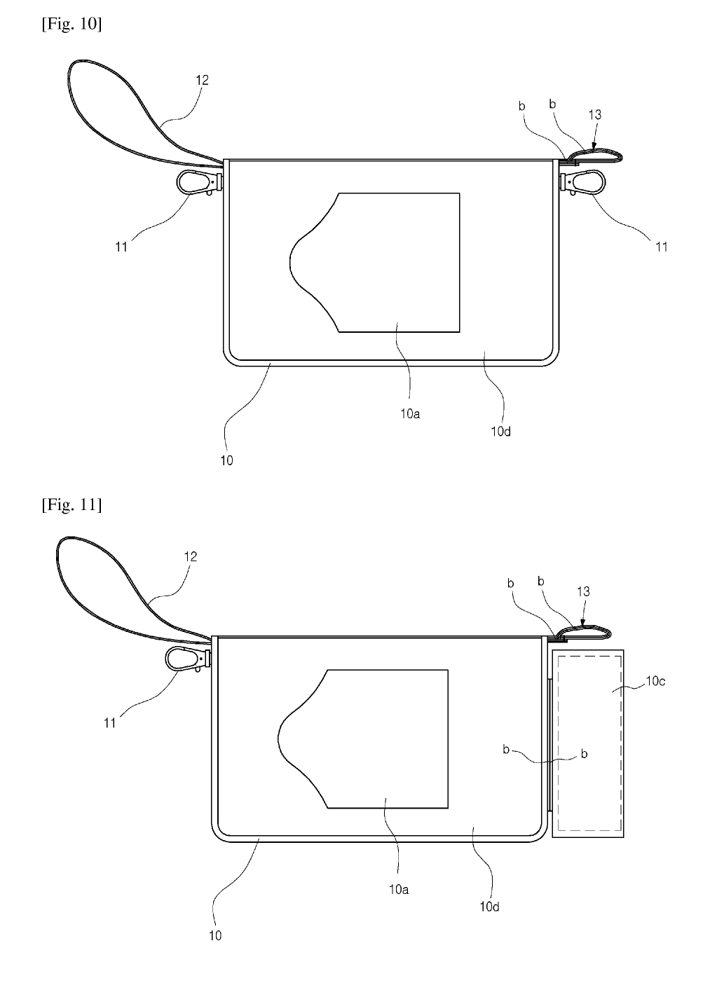

FIG. 10 is a front view of a portable handbag for pet defecation disposal according to a third embodiment of the present invention.

The portable handbag according to the present embodiment is provided with a second hook 11 fixed to the other side of the handbag below the ring 13. The user can fasten the pet lead line to the ring 13 or the second hook 11 selectively as necessary. Of course, it is also possible to remove the ring 13 and use only the second hook 11 according to circumstances.

That is, the means for fastening the handbag to the pet lead line is not limited to a particular one. In addition, since the other configuration is substantially identical to the embodiments described above, its specific description is omitted.

FIG. 11 is a front view of a portable handbag for pet defecation disposal according to a fourth embodiment of the present invention.

The portable handbag according to the present embodiment includes a defecation pocket 10c configured in a separable type. In addition, a male Velcro fastener b is attached on the outside of the container 10, and a female Velcro fastener b is attached on one side of the defecation pocket 10c at the same level with the male Velcro fastener b of the container 10. Therefore, the defecation pocket 10c is detachably coupled with the one side of the handbag by Velcro fasteners b.

Although the present invention has been described in connection with the exemplary embodiments illustrated in the drawings, it is only illustrative. It will be understood by those skilled in the art that various modifications and equivalents can be made to the present invention. Therefore, the true technical scope of the present invention should be defined by the appended claims.

1. A portable handbag for keeping articles for pet defecation disposal, comprising:
a strap provided at an upper end portion of one side of a handbag,
a first hook fixed to the one side of the handbag below the strap, and a ring provided at an upper end portion of the other side of the handbag opposed to the strap.

2. The portable handbag of claim 1, further comprising a second hook fixed to the other side of the handbag below the ring.

3. The portable handbag of claim 1, wherein the ring is a hook.

4. The portable handbag of claim 1, wherein the strap is fastened to the first hook after passing through a handgrip attached to a housing of an automatically wound type lead line.

5. The portable handbag of claim 1, wherein a handgrip of a pet lead line is fastened to the first hook.

6. A portable handbag comprising:
a container having a space to keep wet tissues,
a container cover coupled with the container to open and close the upper side thereof,
a defecation pocket formed on an outside of the container cover to keep defecation bags, and
an auxiliary pocket formed on an outside of the container cover at intervals with the defecation pocket to keep vinyl bags that have collected pet defecation,
wherein the container includes a hole formed on the front thereof to draw out wet tissues kept in the container.

7. The portable handbag of claim 6, wherein the defecation pocket is detachably coupled with the container.

8. The portable handbag of claim 6, further comprising a strap provided at an upper end portion of one side of the container, a first hook fixed to the one side of the container below the strap, and a ring provided at an upper end portion of the other side of the container opposed to the strap.

9. The portable handbag of claim 6, further comprising a cover provided on the front of the container to open and close the hole.
